(19) United States
(12) Patent Application Publication
(10) Pub. No.: US 2026/0143360 A1
(43) Pub. Date: May 21, 2026

(54) SLICE RESOURCE OPTIMIZATION METHOD FOR WIRELESS COMMUNICATION, APPARATUS, AND COMPUTER-READABLE STORAGE MEDIUM

(71) Applicant: ZTE Corporation, Shenzhen (CN)

(72) Inventors: Dapeng LI, Shenzhen (CN); Yin GAO, Shenzhen (CN); Man ZHANG, Shenzhen (CN); Zhuang LIU, Shenzhen (CN); Yansheng LIU, Shenzhen (CN); Jiajun CHEN, Shenzhen (CN)

(73) Assignee: ZTE Corporation, Shenzhen (CN)

(21) Appl. No.: 19/447,849

(22) Filed: Jan. 13, 2026

Related U.S. Application Data
(63) Continuation of application No. PCT/CN2023/107527, filed on Jul. 14, 2023.

(51) Int. Cl. H04W 24/02

(52) U.S. Cl. CPC H04W 24/02

(57) ABSTRACT

A wireless communication method includes obtaining input information, including at least one of: slice measurement result information, one or more first pieces of information, one or more second pieces of information, or inference feedback information and using the input information to perform at least one of model training of a slice radio resource management model or generating an inference output with the slice radio resource management model.

### TECHNICAL FIELD

This disclosure is generally related to wireless communication, and more particularly to optimization of RAN slice resource.

### BACKGROUND

Wireless communication technologies are pivotal components of the increasingly interconnecting global communication networks. Wireless communications rely on accurately allocated time and frequency resources for transmitting and receiving wireless signals. Random Access Network (RAN) resource slicing includes partitioning the RAN resources into multiple slices or segments for different applications and services. For example, a slice can be assigned with a specific set of resources for specific services or users it serves. Distribution and optimization of the assignment of the RAN slice resource is an issue for efficient use of the communication resources of a communication system.

### SUMMARY

This summary is a brief description of certain aspects of this disclosure. It is not intended to limit the scope of this disclosure.

According to some embodiments of this disclosure, a wireless communication method is disclosed. The method includes obtaining input information and using the input information to perform at least one of model training of a slice radio resource management model or generating an inference output with the slice radio resource management model. The input information includes at least one of: slice measurement result information, one or more first pieces of information, one or more second pieces of information, or inference feedback information. The slice measurement result information includes at least one of: UE location information; UE measurement information; or UE capability information. The one or more first pieces of information includes first current or predicted slice available capacity information; first current or predicted shared network slice information; first current or predicted prioritized network slice information; first current or predicted dedicated network slices information; first multi-carrier resource sharing configuration information; first slice radio resource management (RRM) policy or restriction information; resource deployment information; slice-based cell reselection information; slice service level agreements information; PDU session quality of service (QoS) information; information of attribute of the used slice resource; predicted service traffic information; dual connectivity configuration information; validate time information; or confidence information. The one or more second pieces of information includes at least one of: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information.

Still another embodiment of this disclosure provides a wireless communication apparatus, including one or more memory units storing one or more programs and one or more processors electrically coupled to the one or more memory units and configured to execute the one or more programs to perform any method or step or their combinations in this disclosure.

Still another embodiment of this disclosure provides non-transitory computer-readable storage medium, storing one or more programs, the one or more programs being configured to, when performed by at least one processor, cause to perform any method or step or their combinations in this disclosure.

According to some embodiments of this disclosure, one or more wireless communication methods are further disclosed; the methods include combinations of certain methods, aspects, elements, and steps (either in a generic view or specific view) disclosed in the various embodiments or examples of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIGS. 1A and 1B shows handover of UE from a source RAN node to a target RAN node.

FIG. 2 illustrates a functional framework of RAN intelligent slice resource management system.

FIG. 3 shows a flow chart of wireless communication according to some embodiments of this disclosure.

FIG. 4 shows another flow chart of wireless communication according to some embodiments of this disclosure.

FIG. 5 shows another flow chart of wireless communication according to some embodiments of this disclosure.

FIG. 6 shows another flow chart of wireless communication according to some embodiments of this disclosure.

FIG. 7 shows a wireless communication system structure.

### DETAILED DESCRIPTION

The rapid development of mobile communication has penetrated into all aspects of people's work, social life, and life, and has brought a huge impact on people's lifestyle, work style, social politics, economy and other aspects. Human society has entered the information age, and business application requirements in all aspects are showing explosive growth. In the future, mobile networks may not only provide communication between people, but also provide services for mass devices of the Internet of Things and for other purposes.

The differentiated business model and service requirements bring huge challenges to the future wireless mobile broadband systems in terms of frequency, technology, and operation. The traditional communication network, namely the Residential Access Network (RAN) plus core (CORE) is increasingly unable to meet all scenarios.

The development of Network Function Virtualization (NFV) technology makes it possible for operators to build different virtual networks for different business requirements. Network slicing is based on a general physical infrastructure to logically define and divide the network to form an end-to-end virtual network. Each virtual network has different functions and characteristics to dynamically meet various needs and business models.

A regular network slice includes a set of virtualized access network functions and core network functions. Network slicing can be constructed by the operator according to requirements and strategies, and the functions included in a network slice are also determined by the operator according to requirements and strategies. For example, some network slices may include a dedicated forwarding plane in addition to the control plane function, while some network slices may only include some basic control plane functions.

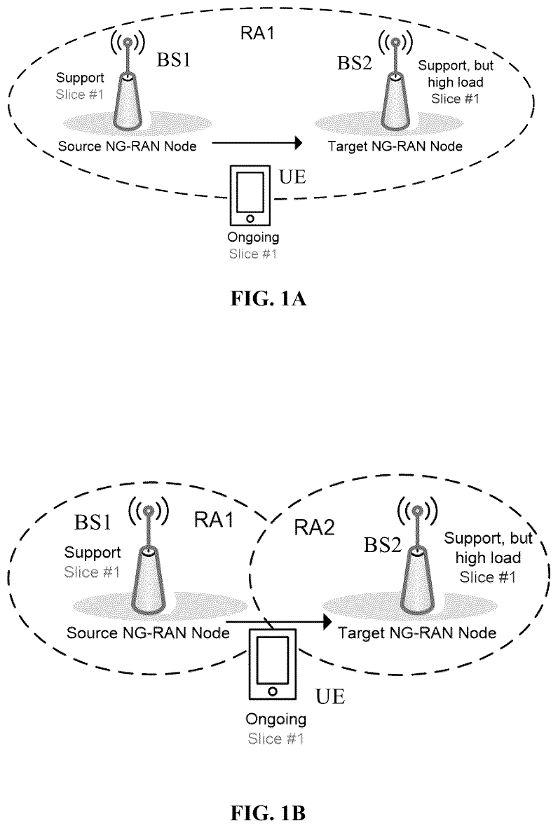

As shown FIG. 1A and FIG. 1B, a UE's (user reequipment) ongoing slice(s) can be supported by both the source and the target NG-RAN nodes when the UE switches from one base station (BS1) to another base station (BS2). However, if the target RAN has been overloaded to have sufficient slice resources for the incoming UE, the UE's connection can be interrupted. It is a technical issue to be overcome for RAN nodes to achieve the better slice resource allocation to ensure UE's service continuity. AI (Artificial Intelligence) functions could be a candidate approach to be used for slice resource allocation prediction based on the data collected and training/inference by the AI models.

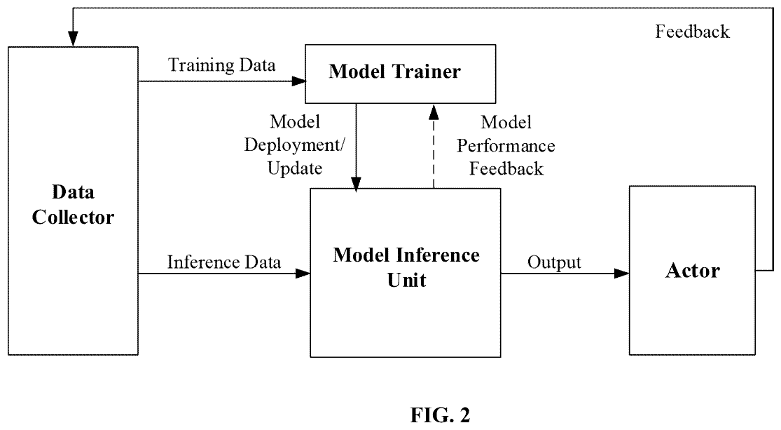

FIG. 2 illustrates a functional framework of RAN intelligent slice resource management system. The RAN intelligent slice resource management system includes a data collector, a model trainer, a model inference unit, and an actor. The data collector receives feedback information from the actor and provides input data to the model trainer and model inference unit. The model trainer is configured to perform model training, such as training of artificial intelligent (AI) or machine learning (ML) models, validation, and testing, which may generate model performance metrics as part of the model testing procedure. The training can include supervised learning, unsupervised learning, reinforcement learning, transfer learning, semi-supervised learning, or self-supervised learning, for example. AI/ML inference generally may include a model or algorithm that represents the knowledge or patterns learned from data, and here the training done by the trainer can be used to prepare the model. The inference data are fed into the model to produce an output or prediction. The AI/ML model here may include at least one of artificial neural networks, decision trees, support vector machines, reinforcement leaning models, ensemble models, generative models, and/or probabilistic models, for example.

The model inference unit is configured to provide AI/ML model inference output based on the inference data provided by the data collector. The output can be predictive or decisive. The inference may include online/real-time inference, batch inference, and edge Inference, for example. The output of the model inference unit may include one or more policies for an actor, such as a core network or a base station, which uses such one or more policies to allocate the slice resources of the communication system. In addition, the actor is configured to monitor the performance of enforcing the output of the model inference unit and feedback related information to the data collector for the future training.

According to some embodiments, the AI/ML model trainer can be located in an OAM (Operations, Administration, and Maintenance) of a core network (CN) and the AI/ML model inference unit can be located in a gNB (or a base station). Alternatively or additionally, the AI/ML model trainer and the AI/ML model inference unit can both be located at the gNB.

Alternatively or additional according to some embodiments in case of gNB-CU (centralized unit) and gNB-DU (distributed unit) structure, the AI/ML model trainer can be located in an OAM, and the AI/ML model inference unit can be located in the gNB-CU. Alternatively or additionally, both the AI/ML model trainer and the AI/ML model inference unit can be located in the gNB-CU. Alternatively or additionally, the AI/ML model trainer can be located in the gNB-CU, and the AI/ML model inference unit can be located in the gNB-DU.

### Input of the AI/ML-Based RAN Slice Resource Allocation

According to some embodiments, the input of the information received by the AI/ML model trainer and/or the input of the AI/ML Model inference unit may include the following.

From a local node where the AI/ML model trainer or the AI/ML model inference unit is located, the input (e.g., assistance information) provided to the AI/ML model trainer or the AI/ML model inference unit (or the data collector) includes at least one of or the combination of the following: first current or predicted slice available capacity information; first current or predicted shared network slice information; first current or predicted prioritized network slice information; first current or predicted dedicated network slices information; first multi-carrier resource sharing configuration information; first slice radio resource management (RRM) policy or restriction information; resource deployment information; slice-based cell reselection information; slice service level agreements information; PDU session quality of service (QoS) information; information of attribute of the used slice resource; predicted service traffic information; dual connectivity configuration information; validate time information; or confidence information. Exemplarily, the current or predicted slice available capacity information indicates the capacity of the available slice source of the local network node. The information can reflect the current status or can be a predicted value (i.e., predicted or current values). The current or predicted shared network slice information can, for example, indicate the status of the shared network slices, such as the usage of the share slices, including PRBs, PRB UL, PRB DL, RRC connected users, and DRBs. The information, for example, can reflect the current status or can be a predicted value. The current or predicted prioritized network slice information can, for example, indicate the status of the prioritized network slices, such as the usage of the share slices, including PRBs (Physical Resource Block), PRB UL (uplink), PRB DL (downlink), RRC (Radio Resource Control) connected users, and DRBs (Data Radio Bearer). The information can reflect the current status or can be a predicted value. The information can, for example, reflect the current status or can be a predicted value. The current or predicted dedicated network slice information can, for example, indicate the status of the prioritized network slices, such as the usage of the share slices, including PRBs, PRB UL, PRB DL, RRC connected users, and DRBs. The information can reflect the current status or can be a predicted value.

For example, the multi-carrier resource sharing configuration information may indicate a function of a RAN, which can setup the dual connectivity or carrier aggregation with different frequency and overlapping coverage where the same slice is available. The slice radio resource management (RRM) policy or restriction information indicates, for example, the policy (e.g., by a policy number) used for slice radio resource management or the restriction of the slice radio resource management. The resource deployment information can indicate, for example, the deployment of the slice resource in frequencies. The slice-based cell reselection information indicates, for example, a capability of a network node or a device to support slice-based cell reselection. The slice service level agreements (SLA) information indicates, for example, the service agreement between a provider and a user. The PDU (Protocol Data Unit) session quality of service (QoS) information includes, for example, GBRs (Guaranteed Bit Rate), Non GBR, Slice MBR (Maximum Bit Rate) and/or Service types. The information of attribute of the used slice resource indicates, for example, preemption attribute of the used sliced resource. The predicted service traffic information indicates, for example, predicted service of a network node. The dual connectivity configuration information indicates, for example, capability or setting of the dual connection of a certain network node or device. The validate time information indicates, for example, a predicted parameter, value, or configuration's expiration time or valid time. The confidence information indicates, for example, how accuracy or reliable a predicted parameter, value, or configuration is.

From user equipment (UE), which uses the slice resource, the input (e.g., RAN slice related measurement results) provided to the AI/ML model trainer or the AI/ML model inference unit (or the intermediary data collector) includes at least one of or the combination of the following: UE location information; UE measurement information; or UE capability information. For example, the UE location information may include, for example, at least one of coordinates of the UE, serving cell ID of the UE, or moving velocity of the UE. The UE measurement information may, for example, include at least one of a UE RSRP (Reference Signal Received Powe) measurement, a RSRQ (Reference Signal Received Quality) measurement, a SINR (Signal-to-Interference-plus-Noise Ratio) measurement, or a data throughput of the UE. The UE capability information may, for example, include the indication of whether the UE support a certain function. For example, it may indicate whether the UE supports slice-based cell reselection.

From one or more neighboring RAN (or neighboring gNB(s), gNB-CU(s), gNB-DU(s)), the input (e.g., assistance information) provided to the AI/ML model trainer or the AI/ML model inference unit (or the intermediary data collector) includes at least one of or the combination of the following: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. Exemplarily, the current or predicted slice available capacity information indicates the capacity of the available slice source of the local network node. The information, for example, can reflect the current status or can be a predicted value. The current or predicted shared network slice information can, for example, indicate the status of the shared network slices, such as the usage of the share slices, including PRBs, PRB UL, PRB DL, RRC connected users, and DRBs. The information can, for example, reflect the current status or can be a predicted value. The current or predicted prioritized network slice information can indicate, for example, the status of the prioritized network slices, such as the usage of the shares slices, including PRBs, PRB UL, PRB DL, RRC connected users, and DRBs. The information can, for example, reflect the current status or can be a predicted value. The information can, for example, reflect the current status or can be a predicted value. The current or predicted dedicated network slice information can, for example, indicate the status of the prioritized network slices, such as the usage of the share slices, including PRBs, PRB UL, PRB DL, RRC connected users, and DRBs. The information can reflect the current status or can be a predicted value.

For example, the multi-carrier resource sharing configuration information may indicate a function of a RAN, which can setup the dual connectivity or carrier aggregation with different frequency and overlapping coverage where the same slice is available. The slice radio resource management (RRM) policy or restriction information indicates, for example, the policy (e.g., by a policy number) used for slice radio resource management or the restriction of the slice radio resource management.

One or more pieces of the information list above from the local RAN, the neighboring RAN, or the UE can be used as an inference feedback received from the actor of the model. The inference feedback information may include at least one of or the combination of the following: shared resource usage feedback information; prioritized resource usage feedback information; dedicated resource usage feedback information; service interruption feedback information; validate time feedback information; system performance feedback information; or (QoS) measurements feedback information. Exemplarily, the shared resource usage feedback information indicates the usage of the shared resources; the prioritized resource usage feedback information, for example, indicates the usage of the prioritized resource; the dedicated resource usage feedback information, for example, indicates the usage of the dedicated resource; the service interruption feedback information indicates the parameters related to the interruption of the service provided by the network node; the validate time feedback information, for example, indicates the valid time or the expiration time of the feedback information; the system performance feedback information may include one or more KPI or other performance index of the actor; the QoS measurements feedback information indicates the measurements of various QoS parameters.

### Output of the Inference

In some examples, the inference output includes at least one of or the combination of the following: random access network (RAN) slice allocation strategy output information, which, for example, indication the allocation strategy of the RAN; cell handover or reselection strategy output information, which, for example, indicates the handover or the reelection strategy of the RAN; predicted shared network slice output information, which, for example, indicates the predicted parameter or status of the shared network slice; predicted prioritized network slice output information, which, for example, indicates the predicted parameter or status of the prioritized network slice; predicted dedicated network slice output information, which, for example, indicates the predicted parameter or status of the dedicated network slice; predicted remapping policy output information, which, for example, indicates the remapping policy of the network resource of a network node; predicted service traffic output information, which, for example, indicates the predicted parameter or status of the service traffic; validate time output information, which, for example, indicates the valid time or expiration time of the above output information.

### Examples of Different Arrangements

The disclosure below describes the communication and operation between various network nodes to obtain the information for further process in order to train the AI/ML models and to perform model inference to generate the configurations/policies of the slice resource arrangement. Regularly, the network node performing the training and inference may send a request to other network nodes, such as neighboring gNBs, for the assistance information, including the information listed above. In addition, one or more UEs may provide the above UE information to the network node performing the training of the model or inference. Once the model is trained or updated, the network node performing the training may send the update information to the network node that performs the inference to set up or update the AI/ML model at such node, if the training node and the inference node are different. Once the inference is performed, the inference node may send the output of the inference to the actor, such as a neighboring gNB. In response, the actor can send the feedback to the training or inference node (optionally, via a data collector) for future training of the model or inference.

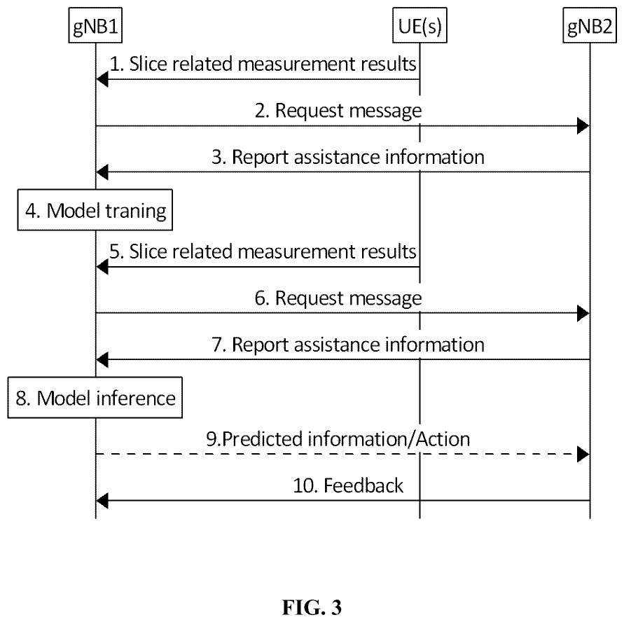

FIG. 3 shows a flow chart of wireless communication according to some embodiments of this disclosure. In this example, the model training and the model inference are performed by a first gNB (gNB1), gNB1. Here, the model trainer and the model inference unit are both arranged at the gNB1. The sequence of the steps below and elsewhere in this disclosure is exemplary, and certain steps may be reordered, skipped or performed repetitively or periodically.

Step1: The one or more UEs report the RAN slice related measurement results to gNB1. In this step, one or more UEs can report some measurements related to the use of the RAN slice resource to the gNB1, such that the measurement information can be used for model training or inference. According to some embodiments, the measurement includes at least one of UE location information; UE measurement information; or UE capability information. The examples of these pieces of information have be explained above, and are applicable here unless explained otherwise.

Step 2: The gNB1 sends a request message to the gNB2 (a neighboring base station) to ask for assistance information for the model training performed by gNB1. The information in the request message may include at least one of the following items: an indication that indicates the requested information to provide from a neighboring RAN (gNB2) to the first RAN of gNB1. According to some example, the pre-defined messages XnAP HANDOVER REQUEST, XnAP AI/ML INFORMATION REQUEST, XnAP RESOURCE STATUS REQUEST, NGAP Uplink RAN Configuration Transfer, or NGAP Downlink RAN Configuration Transfer can be used to carry the request from gNB1 to gNB2. Alternatively or additionally, a new message can be introduced to request assistant information for the slice resource optimization purpose.

Step 3: The gNB2, in response to the request for example, sends the assistance information, for example, via XnAP (Xn Application Protocol) or NGAP (Next Generation Application Protocol) (via an AMF). With such, the gNB1 may perform model training. The assistance information from one or more other gNBs could include at least one of the following items: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. The examples of these pieces of information have be explained above, and are applicable here unless explained otherwise.

As an example, the predefined messages such as XnAP AI/ML INFORMATION RESPONSE, XnAP RESOURCE STATUS UPDATE, NGAP Uplink RAN Configuration Transfer, or NGAP Downlink RAN Configuration Transfer can be reused for the purpose. Alternatively or additionally, a new message can be introduced to request assistant information for the slice resource optimization purpose.

An example of IE (information element) design in the message provide from gNB2 to gNB1 is shown in the Table 1 below.

TABLE 1

| | | | | Exemplary |
|---|---|---|---|---|
| | | | IE type and | Semantics |
| IE/Group Name | Presence | Range | reference | description |
| Predicted Slice | | 1 . . . | | |
| Available | | <maxnoofBPLMNs> | | |
| Capacity | | | | |
| >PLMN Identity | M | | 9.2.2.4 | Broadcast PLMN |
| >Predicted S- | | 1 | | |
| NSSAI Available | | | | |
| Capacity List | | | | |
| >>S-NSSAI | M | 1 . . . | | |
| Available | | <maxnoofSliceItems> | | |
| Capacity Item | | | | |
| >>>S-NSSAI | | | 9.2.3.21 | |
| >>>Slice | O | | INTEGER | Value 0 indicates no |
| Available | | | (0 . . . 100) | available capacity, |
| Capacity Value | | | | and 100 indicates |
| Downlink | | | | maximum available |
| | | | | capacity. Slice |
| | | | | Available Capacity |
| | | | | Value Downlink |
| | | | | should be measured |
| | | | | on a linear scale. |
| >>>Slice | O | | INTEGER | Value 0 indicates no |
| Available | | | (0 . . . 100) | available capacity, |
| Capacity Value | | | | and 100 indicates |
| Uplink | | | | maximum available |
| | | | | capacity. Slice |
| | | | | Available Capacity |
| | | | | Value Uplink should |
| | | | | be measured on a |
| | | | | linear scale. |
| >>>Shared | O | | INTEGER | The IE represents the |
| Slice capacity | | | (0 . . . 100) | ratio of available |
| ratio | | | | capacity of the |
| | | | | shared part of the S- |
| | | | | NSSAI. |
| >>>Dedicated | O | | INTEGER | The IE represents the |
| Slice capacity | | | (0 . . . 100) | ratio of available |
| ratio | | | | capacity of the |
| | | | | Dedicated part of the |
| | | | | S-NSSAI. |
| >>>Prioritize | O | | INTEGER | The IE represents the |
| Slice capacity | | | (0 . . . 100) | ratio of available |
| ratio | | | | capacity of the |
| | | | | shared part of the S- |
| | | | | NSSAI. |
| >>>Resource | O | | ENUMERATED | The Prioritize and or |
| Repartitioning | | | (true, false, . . .) | Dedicated Slice can |
| | | | | be repartitioning |
| | | | | when the IE set to |
| | | | | true. |

Step 4: The gNB1 performs model training based on at least one of the slice related measurement results received from the UE and the assistance information received from other neighboring gNB(s) to predict the slice configuration results. The training may generate or update the AI/ML model for the inference to generate the slice configuration of the RAN.

Step 5: The UE sends the slice related measurement results and assistance information to the gNB1 as it does in Step 1. In this step, the UE may update the slice related measurement results to the gNB1. In some examples, the update of the slice related measurement results can be provided to gNB1 periodically.

Steps 6-7: For model inference, gNB1 sends the request to gNB2 to ask for assistance information for model inference. The details of the request and the feedback have been explained at Steps 2-3.

Step 8: The gNB1 performs model inference based on at least one of the slice related measurement results received from the UE and the assistance information received from other neighboring gNB(s) to predict the RAN slice resource allocation/configuration. The output of the inference can include a configuration for allocation of the slice resource. Exemplarily, the output of the inference may include random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information. The examples of these pieces of information have be explained above, and are applicable here unless explained otherwise.

Step 9: The gNB1 sends the predicted information to the neighboring gNB(s), such as gNB2, via XnAP or NGAP. In some examples, the inference output includes at least one of or the combination of the following: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information. The examples of these pieces of information have be explained above, and are applicable here unless explained otherwise.

Step 10: The gNB2 sends the inference feedback information to the gNB1. The inference feedback may include at least one of or the combination of the following: shared resource usage feedback information; prioritized resource usage feedback information; dedicated resource usage feedback information; service interruption feedback information; validate time feedback information; service interruption times; system performance feedback information; or (QoS) measurements feedback information. The examples of these pieces of information have be explained above, and are applicable here unless explained otherwise.

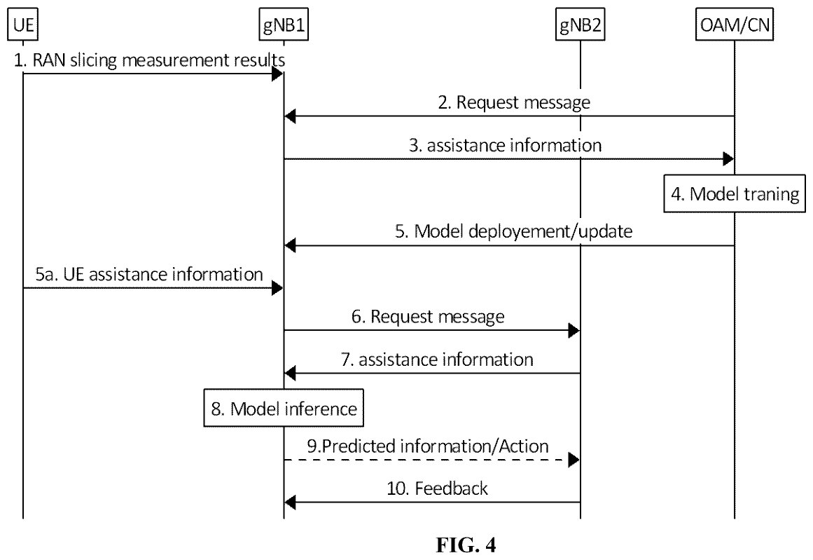

FIG. 4 shows another flow chart of the wireless communication according to some embodiments of this disclosure. In this example, the model training is performed by the OAM/CN (core network), and the model inference is performed by a first gNB (gNB1), gNB1.

Step 1: The one or more UEs report the RAN slice related measurement results to gNB-CU. In this step, one or more UEs can report some measurements related to the use of the RAN slice resource to the gNB1, such that the measurement information can be used for model training or inference. According to some embodiments, the measurement includes at least one of UE location information; UE measurement information; or UE capability information. The examples of these pieces of information have be explained above, and are applicable here unless explained otherwise.

Step 2: The OAM/CN sends a request message to the gNB1 (a neighboring base station) to ask for assistance information for the model training performed by OAM. The information in the request message may include at least one of the following items: an indication that indicates the requested information to provide from a neighboring RAN to the first RAN of gNB1.

Step 3: The gNB1, in response to the request for example, sends the assistance information to the OAM/CN. With such, the OAM/CN may to perform model training. The assistance information from one or more other gNBs could include at least one of the following items: first current or predicted slice available capacity information; first current or predicted shared network slice information; first current or predicted prioritized network slice information; first current or predicted dedicated network slices information; first multi-carrier resource sharing configuration information; first slice radio resource management (RRM) policy or restriction information; resource deployment information; slice-based cell reselection information; slice service level agreements information; PDU session quality of service (QoS) information; information of attribute of the used slice resource; predicted service traffic information; dual connectivity configuration information; validate time information; or confidence information. The examples of these pieces of information have be explained above, and are applicable here unless explained otherwise. An example of IE (information element) design in the message provide from gNB1 to OAM/CN is shown in the Table 1 above.

Step 4: The OAM/CN performs model training based on at least one of the slice related measurement results received from the UE and the assistance information received from other neighboring gNB(s) to predict the slice configuration results. The training may generate or update the AI/ML model for the inference to generate the slice configuration of the RAN.

Step 5: The OAM/CN sends the AI/ML model's update or configuration to the gNB1 to update or set up the AI/ML model at gNB1.

Step 5a: The UE sends the slice related measurement results and assistance information to the gNB1 as in the Step 1. In this step, the UE may update the slice related measurement results to the gNB1. In some examples, the update of the slice related measurement results can be provided to gNB1 periodically.

Step 6: The gNB1 sends a request message to the gNB2 (a neighboring base station) to ask for assistance information for the model training performed by gNB1. The information in the request message may include at least one of the following items: an indication that indicates the requested information to provide from a neighboring RAN (gNB2) to the first RAN of gNB1. According to some example, the messages XnAP HANDOVER REQUEST, XnAP AI/ML INFORMATION REQUEST, XnAP RESOURCE STATUS REQUEST, NGAP Uplink RAN Configuration Transfer, NGAP Downlink RAN Configuration Transfer can be used to carry the request from gNB1 to gNB2. Alternatively or additionally, a new message can be introduced to request assistant information of slice resource optimization purpose.

Step 7: The gNB2, in response to the request for example, sends the assistance information, for example, via XnAP (Xn Application Protocol) or NGAP (Next Generation Application Protocol) (via AMF). With such, the gNB1 may perform model inference. The assistance information from one or more other gNBs could include at least one of the following items: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. The examples of these pieces of information have be explained above, and are applicable here unless explained otherwise.

As an example, the predefined messages such as XnAP AI/ML INFORMATION RESPONSE, XnAP RESOURCE STATUS UPDATE, NGAP Uplink RAN Configuration Transfer, or NGAP Downlink RAN Configuration Transfer can be reused for the purpose Alternatively or additionally, a new message can be introduced to request assistant information of slice resource optimization purpose. An example of IE (information element) design in the message provide from gNB2 to gNB1 is shown in the Table 1 above.

Step 8: The gNB1 performs model inference based on at least one of the slice related measurement results received from the UE and the assistance information received from other neighboring gNB(s) to predict the RAN slice resource allocation/configuration. The output of the inference can include a configuration for allocation of the slice resource. In some examples, the inference output includes at least one of or the combination of the following: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information.

Step 9: The gNB1 sends the predicted information to the neighboring gNB(s), such as gNB2, via XnAP or NGAP. In some examples, the inference output includes at least one of or the combination of the following: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information. The examples of these pieces of information have be explained above, and are applicable here unless explained otherwise.

Step 10: The gNB2 sends the inference feedback information to the gNB1. The inference feedback may include at least one of or the combination of the following: shared resource usage feedback information; prioritized resource usage feedback information; dedicated resource usage feedback information; service interruption feedback information; validate time feedback information; service interruption times; system performance feedback information; or (QoS) measurements feedback information. The examples of these pieces of information have be explained above, and are applicable here unless explained otherwise.

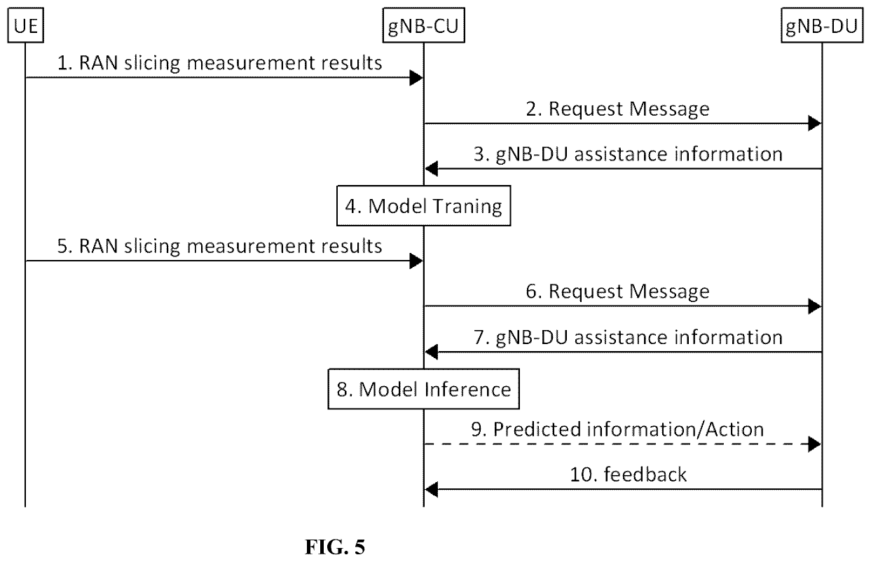

FIG. 5 shows another flow chart of wireless communication according to some embodiments of this disclosure. In this example, the gNB is arranged as a gNB-CU and gNB-DU split arrangement. In this example, the model training and the model inference are performed by the gNB-CU. Here, the model trainer and the model inference unit are both arranged at the gNB-CU.

Step 1: The one or more UEs report the RAN slice related measurement results to the gNB-CU. In this step, one or more UEs can report some measurements related to the use of the RAN slice resource to the gNB-CU, such that the measurement information can be used for model training or inference. According to some embodiments, the measurement includes at least one of UE location information; UE measurement information; or UE capability information. The examples of these pieces of information have be explained above, and are applicable here unless explained otherwise.

Step 2: The gNB-CU sends a request message to the gNB-DU to ask for assistance information for the model training performed by gNB-CU. The information in the request message may include at least one of the following items: an indication that indicates the requested information to provide from a gNB-DU to the gNB-CU. According to some example, the messages can be sent via the F1AP (F1 Application Protocol). Alternatively or additionally, a new message can be introduced to request assistant information of slice resource optimization purpose.

Step 3: The gNB-DU, in response to the request for example, sends the assistance information, for example, via an FAP. With such, the gNB1 may perform model training. The assistance information from one or more other gNB-DUs could include at least one of the following items: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. An example of IE (information element) design in the message provide from gNB-DU to gNB-CU is shown in the Table 1 above. The examples of these pieces of information have be explained above, and are applicable here unless explained otherwise.

Step 4: The gNB-CU performs model training based on at least one of the slice related measurement results received from the UE and the assistance information received from other gNB-DUs to predict the slice configuration results. The training may generate or update the AI/ML model for the inference to generate the slice configuration of the RAN.

Step 5: The UE sends the slice related measurement results and assistance information to the gNB-CU as in the Step 1. In this step, the UE may update slice related measurement results to the gNB-CU. In some examples, the update of the slice related measurement results can be provided to gNB-CU periodically.

Steps 6-7: For model inference, gNB-CU sends the request to gNB-DU to ask for assistance information for model inference via F1AP. The details of the request and the feedback have been explained at Steps 2-3.

Step 8: The gNB-CU performs model inference based on at least one of the slice related measurement results received from the UE and the assistance information received from other gNB-DUs to predict the RAN slice resource allocation. The output of the inference can include a configuration for allocation of the slice resource.

Step 9: The gNB-CU sends the predicted information to the gNB-DU(s) via an F1AP. In some examples, the inference output includes at least one of or the combination of the following: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information. The examples of these pieces of information have be explained above, and are applicable here unless explained otherwise.

Step 10: The gNB-DU sends the inference feedback information to the gNB-CU via an F1AP, for example. The inference feedback may include at least one of or the combination of the following: shared resource usage feedback information; prioritized resource usage feedback information; dedicated resource usage feedback information; service interruption feedback information; validate time feedback information; service interruption times; system performance feedback information; or (QoS) measurements feedback information. The examples of these pieces of information have be explained above, and are applicable here unless explained otherwise.

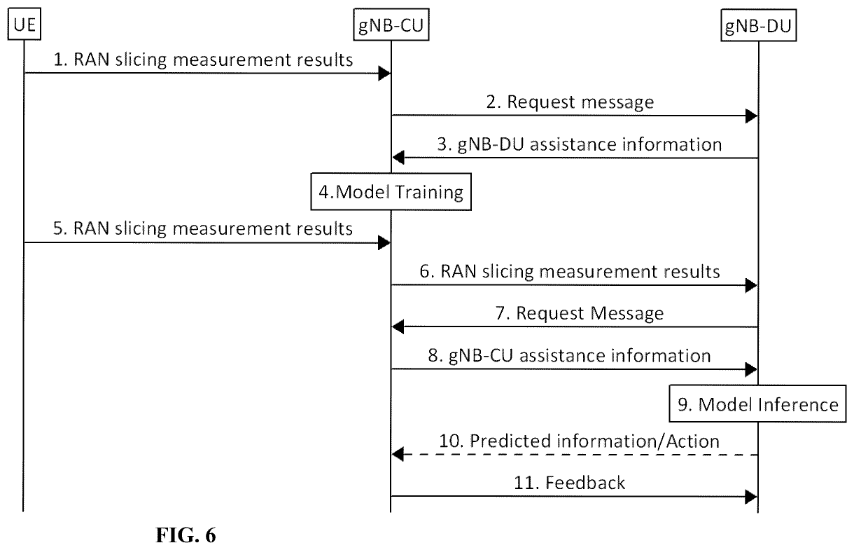

FIG. 6 shows another flow chart of the wireless communication according to some embodiments of this disclosure. In this example, the gNB is arranged as a gNB-CU and gNB-DU split arrangement. In this example, the model training can be performed by gNB-CU, and the model inference can be performed by the gNB-DU.

Step 1: The one or more UEs report the RAN slice related measurement results to gNB-CU. In this step, one or more UEs can report some measurements related to the use of the RAN slice resource to the gNB-CU, such that the measurement information can be used for model training or inference. According to some embodiments, the measurement includes at least one of UE location information; UE measurement information; or UE capability information. The examples of these pieces of information have be explained above, and are applicable here unless explained otherwise.

Step 2: The gNB-CU sends a request message to the gNB-DU to ask for assistance information for the model training performed by gNB-CU. The information in the request message may include at least one of the following items: an indication that indicates the requested information to provide from a gNB-DU to the gNB-CU. According to some example, the messages can be sent via the F1AP (F1 Application Protocol). Alternatively or additionally, a new message can be introduced to request assistant information of slice resource optimization purpose.

Step 3: The gNB-DU, in response to the request for example, sends the assistance information, for example, via an F1AP. With such, the gNB1 may perform model training. The assistance information from one or more other gNB-DUs could include at least one of the following items: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. The examples of these pieces of information have be explained above, and are applicable here unless explained otherwise. An example of IE (information element) design in the message provide from gNB-DU to gNB-CU is shown in the Table 1 above.

Step 4: The gNB-CU performs model training based on at least one of the slice related measurement results received from the UE and the assistance information received from other gNB-DUs to predict the slice configuration results. The training may generate or update the AI/ML model for the inference to generate the slice configuration of the RAN.

Step 5: The UE sends the slice related measurement results and assistance information to the gNB-CU as in the Step 1. In this step, the UE may update slice related measurement results to the gNB-CU. In some examples, the update of the slice related measurement results can be provided to gNB-CU periodically.

Step 6: The gNB-CU forwards the received slice related measurement results from the UE to the gNB-DU.

Step 7: The gNB-DU sends a request message to the gNB-CU to ask for assistance information for the model inference performed by gNB-DU. The information in the request message may include at least one of the following items: an indication that indicates the requested information to provide from a gNB-CU to the gNB-DU. According to some example, the messages can be sent via the F1AP (F1 Application Protocol). Alternatively or additionally, a new message can be introduced to request assistant information of slice resource optimization purpose.

Step 8: The gNB-CU, in response to the request for example, sends the assistance information, for example, via an F1AP. With such, the gNB-DU may perform model inference. The assistance information from the gNB-CU could include at least one of the following items: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information. The examples of these pieces of information have be explained above, and are applicable here unless explained otherwise. An example of IE (information element) design in the message provide from gNB-DU to gNB-CU is shown in the Table 1 above.

Step 9: The gNB-DU performs model inference based on at least one of the slice related measurement results received from the UE and the assistance information received from other gNB-CU to predict the RAN slice resource allocation/configuration. The output of the inference can include a configuration for allocation of the slice resource.

Step 10: The gNB-DU sends the predicted information to the gNB-CU via an F1AP. In some examples, the inference output includes at least one of or the combination of the following: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information. The examples of these pieces of information have be explained above, and are applicable here unless explained otherwise.

Step 11: The gNB-CU sends the inference feedback information to the gNB-DU via an F1AP, for example. The inference feedback may include at least one of or the combination of the following: shared resource usage feedback information; prioritized resource usage feedback information; dedicated resource usage feedback information; service interruption feedback information; validate time feedback information; service interruption times; system performance feedback information; or (QoS) measurements feedback information. The examples of these pieces of information have be explained above, and are applicable here unless explained otherwise.

The various arrangements above can be used in different applications to best fit the applications. Use of the AI/ML model to instruct the action or configured the allocation of the slice resource allow the resource to be use efficiently in view of the collected data and trained model.

According to some embodiments of this disclosure, a wireless communication method is disclosed. The method includes obtaining input information and using the input information to perform at least one of model training of a slice radio resource management model or generating an inference output with the slice radio resource management model. The input information includes at least one of: slice measurement result information, one or more first pieces of information, one or more second pieces of information, or inference feedback information. The slice measurement result information includes at least one of: UE location information; UE measurement information; or UE capability information. The one or more first pieces of information includes at least one of: first current or predicted slice available capacity information; first current or predicted shared network slice information; first current or predicted prioritized network slice information; first current or predicted dedicated network slices information; first multi-carrier resource sharing configuration information; first slice radio resource management (RRM) policy or restriction information; resource deployment information; slice-based cell reselection information; slice service level agreements information; PDU session quality of service (QoS) information; information of attribute of the used slice resource; predicted service traffic information; dual connectivity configuration information; validate time information; or confidence information. The one or more second pieces of information includes at least one of: second current or predicted slice available capacity information; second current or predicted shared network slice information; second current or predicted prioritized network slice information; second current or predicted dedicated network slices information; second multi-carrier resource sharing configuration information; or second slice radio resource management (RRM) policy or restriction information.

According to some examples, the inference output includes at least one of: random access network (RAN) slice allocation strategy output information; cell handover or reselection strategy output information; predicted shared network slice output information; predicted prioritized network slice output information; predicted dedicated network slice output information; predicted remapping policy output information; predicted service traffic output information; or validate time output information.

According to some examples, the inference feedback information includes at least one of: shared resource usage feedback information; prioritized resource usage feedback information; dedicated resource usage feedback information; service interruption feedback information; validate time feedback information; service interruption times; system performance feedback information; or (QoS) measurements feedback information.

According to some examples, using the input information to perform at least one of model training or generating the inference output includes performing the model training and generating of the inference output by a first network node. The method further includes receiving the slice measurement result information of user equipment (UE); sending the inference output to a second network node; and receiving the inference feedback information form the second network node.

According to some examples, the method further comprises sending, by the first network node to the second network node, a first request for the first inference model input information for the training; and sending, by the first network node to the second network node, a second request for the first inference model input information for generating the inference output.

According to some examples, the first network node is a first base station and the second network node is a second base station.

According to some examples, the first network node is a base station centralized unit and the second network node is a base station distributed unit.

According to some examples, using the input information to perform at least one of model training or generating the inference output includes performing the model training by a third network node.

According to some examples, the method further includes sending, according to a result of the training by the third network node, a model deployment or update information to a first network node to prepare the slice radio resource management model, which the first network node uses to generate the inference output.

According to some examples, the third network node comprises an OAM (Operations, Administration, and Maintenance) unit of a core network.

According to some examples, using the input information to perform at least one of model training or generating the inference output includes generating the inference output by a first network node based on the slice radio resource management model trained by a third network node.

According to some examples, the method further includes sending, by the first network node to the second network node, a first request for the one or more first pieces of information for generating the inference output; and sending, by the first network node to the second network node, the inference output.

According to some examples, using the input information to perform at least one of model training or generating the inference output includes performing the model training by a first network node. The method further includes sending, by a first network node to a second network node according to a result of the training by the first network node, a model deployment or update information to prepare the slice radio resource management model, which the second network node uses to generate the inference output.

According to some examples, using the input information to perform at least one of model training of a slice radio resource management model or generating the inference output includes generating the inference output by a second network node based on the slice radio resource management model trained by a first network node.

According to some examples, the method further includes sending, by the second network node to the first network node, a first request for the one or more first pieces of information for generating the inference output; and sending, by the second network node to the first network node, the inference output.

According to some examples, the first network node is a base station centralized unit and the second network node is a base station distributed unit.

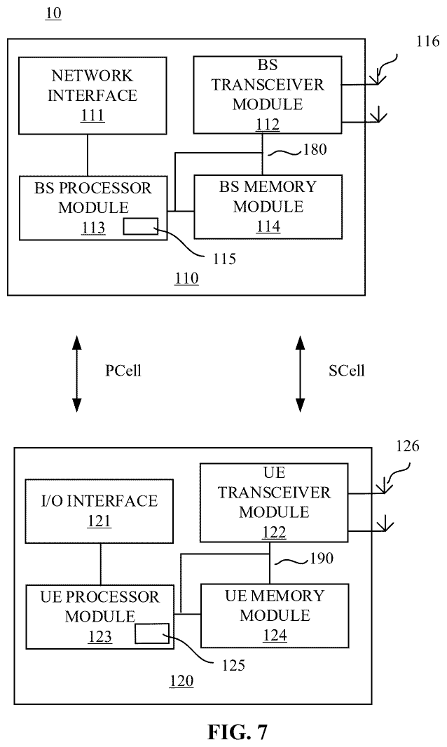

FIG. 7 illustrates a block diagram of an exemplary wireless communication system 10, in accordance with some embodiments of this disclosure. The system 10 may perform the methods/steps and their combination disclosed in this disclosure. The system 10 may include components and elements configured to support operating features that need not be described in detail herein.

The system 10 may include a base station (BS) 110 and user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a data communication bus 190. The BS 110 communicates with the UE 120 via communication channels therebetween, which can be any wireless channel or other medium known in the art suitable for transmission of data as described herein. The channels may include carriers of PCells and SCells.

The processor modules 113, 123 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, respectively, or in any practical combination thereof. The memory modules 113, 123 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124 may be coupled to the processor modules 113, 123 respectively, such that the processors modules 113, 123 can read information from, and write information to, memory modules 114, 124 respectively. The memory modules 114, 124 may also be integrated into their respective processor modules 113, 123. In some embodiments, the memory modules 114, 124 may each include a cache memory for storing temporary variables or other intermediate information during execution of instructions to be performed by processor modules 113, 123, respectively. The memory modules 114, 124 may also each include non-volatile memory for storing instructions to be performed by the processor modules 113, 123, respectively.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
obtaining input information, comprising at least one of:
slice measurement result information, comprising at least one of:
UE location information;
UE measurement information; or
UE capability information;
one or more first pieces of information, comprising at least one of:
first current or predicted slice available capacity information;
first current or predicted shared network slice information;
first current or predicted prioritized network slice information;
first current or predicted dedicated network slices information;
first multi-carrier resource sharing configuration information;
first slice radio resource management (RRM) policy or restriction information;
resource deployment information;
slice-based cell reselection information;
slice service level agreements information;
PDU session quality of service (QoS) information;
information of attribute of the used slice resource;
predicted service traffic information;
dual connectivity configuration information;
validate time information; or
confidence information;
one or more second pieces of information, comprising at least one of:
second current or predicted slice available capacity information;
second current or predicted shared network slice information;
second current or predicted prioritized network slice information;
second current or predicted dedicated network slices information;
second multi-carrier resource sharing configuration information; or
second slice radio resource management (RRM) policy or restriction information; or
inference feedback information; and
using the input information to perform at least one of model training of a slice radio resource management model or generating an inference output with the slice radio resource management model.

2. The method of claim 1, wherein the inference output comprises at least one of:
random access network (RAN) slice allocation strategy output information;
cell handover or reselection strategy output information;
predicted shared network slice output information;
predicted prioritized network slice output information;
predicted dedicated network slice output information;
predicted remapping policy output information;
predicted service traffic output information; or validate time output information.

3. The method of claim 1, wherein the inference feedback information comprises at least one of:
shared resource usage feedback information;
prioritized resource usage feedback information;
dedicated resource usage feedback information;
service interruption feedback information;
validate time feedback information;
service interruption times;
system performance feedback information; or
QoS measurements feedback information.

4. The method of claim 1, wherein using the input information to perform at least one of model training or generating the inference output comprises performing the model training and generating of the inference output by a first network node, the method further comprising:
receiving the slice measurement result information of user equipment (UE);
sending the inference output to a second network node; and
receiving the inference feedback information form the second network node.

5. The method of claim 4, further comprising:
sending, by the first network node to the second network node, a first request for the one or more second pieces of information for the training; and
sending, by the first network node to the second network node, a second request for the one or more second pieces of information for generating the inference output.

6. The method of claim 4, wherein the first network node is a first base station and the second network node is a second base station.

7. The method of claim 4, wherein the first network node is a base station centralized unit and the second network node is a base station distributed unit.

8. The method of claim 1, wherein using the input information to perform at least one of model training or generating the inference output comprises performing the model training by a third network node.

9. The method of claim 8, further comprising sending, according to a result of the training by the third network node, a model deployment or update information to a first network node to prepare the slice radio resource management model, which the first network node uses to generate the inference output.

10. The method of claim 8, wherein the third network node comprises an OAM (Operations, Administration, and Maintenance) unit of a core network.

11. The method of claim 1, wherein using the input information to perform at least one of model training or generating the inference output comprises generating the inference output by a first network node based on the slice radio resource management model trained by a third network node.

12. The method of claim 11, further comprising:
sending, by the first network node to a second network node, a first request for the one or more first pieces of information for generating the inference output; and
sending, by the first network node to the second network node, the inference output.

13. The method of claim 1, wherein using the input information to perform at least one of model training or generating the inference output comprises performing the model training by a first network node, the method further comprising:
sending, by a first network node to a second network node according to a result of the training by the first network node, a model deployment or update information to prepare the slice radio resource management model, which the second network node uses to generate the inference output.

14. The method of claim 1, wherein using the input information to perform at least one of model training of a slice radio resource management model or generating the inference output comprises generating the inference output by a second network node based on the slice radio resource management model trained by a first network node.

15. The method of claim 14, further comprising:
sending, by the second network node to the first network node, a first request for the one or more first pieces of information for generating the inference output; and
sending, by the second network node to the first network node, the inference output.

16. The method of claim 14, wherein the first network node is a base station centralized unit and the second network node is a base station distributed unit.

17. The method of claim 1, wherein, when the input information comprises the second current or predicted slice available capacity information, the second current or predicted slice available capacity information comprises, for each S-NSSAI, respective downlink and uplink slice available capacity values measured on a linear scale.

18. The method of claim 1, wherein the inference output comprises a RAN slice allocation strategy based on the capacity values.

19. A wireless communication apparatus comprising:
one or more memory units storing one or more programs; and
one or more processors electrically coupled to the one or more memory units and configured to execute the one or more programs to:
obtain input information comprising at least one of slice measurement result information, one or more first pieces of information, one or more second pieces of information, or inference feedback information; and
perform, using the input information, at least one of model training of a slice radio resource management model or generating an inference output with the slice radio resource management model.

20. A wireless communication method comprising:
receiving, from one or more neighboring radio access network (RAN) nodes, for each S-NSSAI, respective downlink and uplink slice available capacity values measured on a linear scale; and
generating, by a slice radio resource management model, a RAN slice allocation strategy based on the received capacity values.
